(19) United States
(12) Patent Application Publication
(10) Pub. No.: US 2026/0073812 A1
(43) Pub. Date: Mar. 12, 2026

(54) System and Method for Training Vehicle Operators

(71) Applicant: KB Intellectual Property GmbH &Co. KG, Pullach (DE)

(72) Inventors: Andrew J. Pilkington, Avon Lake, OH (US); Thomas J. Thomas, Brunswick, OH (US)

(21) Appl. No.: 18/826,691

(22) Filed: Sep. 6, 2024

(51) Int. Cl. G09B 19/16; G07C 5/02

(52) U.S. Cl. CPC G09B 19/167; G07C 5/02

(57) ABSTRACT

A system for training an operator of a vehicle includes a database including a plurality of training resources and a controller. The controller receives, over a telecommunications channel, a dataset from the vehicle relating to a safety event occurring during operation of the vehicle by the operator and determines whether the dataset corresponds to a predetermined dataset. If not, the controller transmits a first control signal to the vehicle to adjust a value of a parameter associated with operation of the vehicle from a first value to a second value and generates a training module for the operator including at least one of the plurality of training resources. The controller determines whether use of the training module by the operator meets a predetermined condition and, if so, transmits a second control signal to the vehicle to restore the value of the parameter to the first value.

### BACKGROUND OF THE INVENTION

### A. Field of the Invention

This disclosure relates to a system and method for training vehicle operators. In particular, this disclosure relates to a system and method that allow for customization of vehicle operator training and vehicle operation based on factors including prior operation of the vehicle by the vehicle operator and training preferences by the vehicle owner (e.g., a fleet operator) and/or that increase the likelihood that a vehicle operator will perform suggested training.

### B. Background Art

Management of commercial vehicle fleets requires oversight and training of vehicle operators to promote safe operation of vehicles within the fleet and avoid potential losses from damage to the vehicles, loads carried by the vehicles, and surrounding objects (e.g., other vehicles and road infrastructure) and/or injuries to vehicle operators and other individuals (e.g., pedestrians or occupants of other vehicles). Various systems have been developed that record and store data relating to the operation of vehicles by vehicle operators and that allow fleet managers to identify operators that need additional training on one or more aspects of operating a vehicle. These systems may also be configured to generate training materials for the operator based on the data obtained from operation of the vehicles.

Conventional systems for training vehicle operators have several drawbacks. Conventional systems generate training materials that are often generic in nature and are not directly related to the actions of the vehicle operator. Conventional systems also generate training materials based on standards that are established by the system developer as opposed to fleet managers. As a result, operator training is not customized to the needs of the vehicle operator or the vehicle owner. Further, the standards can be set at a level that results in generation of excessive and disruptive amounts of training for vehicle operators. Conventional systems also lack mechanisms to ensure that operators complete suggested training before resuming full operation of a vehicle.

The inventors herein have recognized a need for a system and method for training an operator of a vehicle that will minimize and/or eliminate one or more of the above-identified deficiencies.

### BRIEF SUMMARY OF THE INVENTION

This disclosure relates to a system and method for training vehicle operators. In particular, this disclosure relates to a system and method that allow for customization of vehicle operator training and vehicle operation based on factors including prior operation of the vehicle by the vehicle operator and training preferences by the vehicle owner (e.g., a fleet operator) and/or that increase the likelihood that a vehicle operator will perform suggested training.

An embodiment of a system for training an operator of a vehicle includes a database including a plurality of training resources and a controller. The controller is configured to receive, over a telecommunications channel, a vehicle operation dataset from the vehicle relating to a safety event occurring during operation of the vehicle by the operator. The controller is further configured to determine whether the vehicle operation dataset corresponds to a predetermined dataset. In some embodiments, the controller is configured to receive tuning signals (from, for example, a vehicle owner) configured to establish the predetermined dataset. The controller is further configured to transmit, if the vehicle operation dataset does not correspond to the predetermined dataset, a first control signal to the vehicle over the telecommunications channel. The first control signal is configured to adjust a value of a parameter associated with operation of the vehicle from a first value to a second value. The controller is further configured to generate, if the vehicle operation dataset does not correspond to the predetermined dataset, a training module for the operator wherein the training module includes at least one of the plurality of training resources. In some embodiments, the training module includes data from the vehicle operation dataset. The controller is further configured to determine whether use of the training module by the operator meets a predetermined condition. The controller is further configured to transmit, if use of the training module by the operator meets the predetermined condition, a second control signal to the vehicle over the telecommunications channel, the second control signal configured to restore the value of the parameter associated with operation of the vehicle to the first value.

An embodiment of a method for training an operator of a vehicle includes receiving, over a telecommunications channel, a vehicle operation dataset from the vehicle relating to a safety event occurring during operation of the vehicle by the operator. The method further includes determining whether the vehicle operation dataset corresponds to a predetermined dataset. In some embodiments, the controller is configured to receive tuning signals (from, for example, a vehicle owner) configured to establish the predetermined dataset. The method further includes transmitting, if the vehicle operation dataset does not correspond to the predetermined dataset, a first control signal to the vehicle over the telecommunications channel. The first control signal is configured to adjust a value of a parameter associated with operation of the vehicle from a first value to a second value. The method further includes generating, if the vehicle operation dataset does not correspond to the predetermined dataset, a training module for the operator wherein the training module includes at least one of a plurality of training resources from a database. In some embodiments, the training module includes data from the vehicle operation dataset. The method further includes determining whether use of the training module by the operator meets a predetermined condition. The method further includes transmitting, if use of the training module by the operator meets the predetermined condition, a second control signal to the vehicle over the telecommunications channel, the second control signal configured to restore the value of the parameter associated with operation of the vehicle to the first value.

A system and method for training an operator of a vehicle in accordance with the teachings disclosed herein is advantageous relative to conventional systems and methods. In particular, various embodiments of the system and method disclosed herein allow for customization of vehicle operator training based on factors including prior operation of the vehicle by the vehicle operator and training preferences by the vehicle owner and/or increase the likelihood that a vehicle operator will perform suggested training.

The foregoing and other aspects, features, details, utilities, and advantages of the present teachings will be apparent from reading the following description and claims, and from reviewing the accompanying drawings.

### BRIEF DESCRIPTION OF THE DRAWINGS

FIG. 1 is a diagrammatic view of a system for training an operator of a vehicle in accordance with the teachings set forth herein.

FIG. 2 is a flow chart diagram illustrating several steps in one embodiment of a method for training an operator of a vehicle in accordance with the teachings set forth herein.

### DETAILED DESCRIPTION OF THE INVENTION

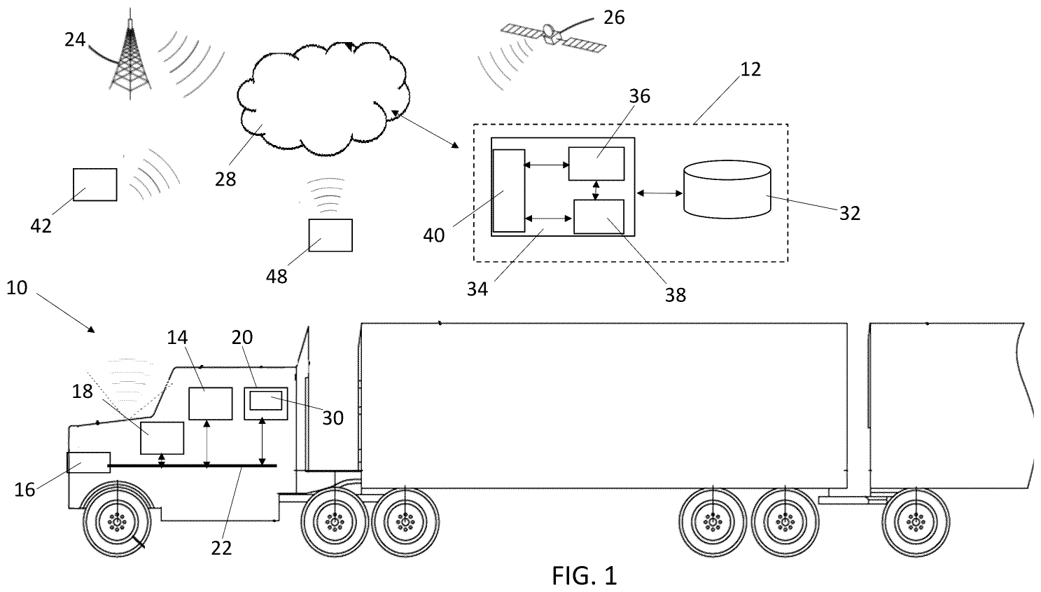

Referring now to the drawings wherein like reference numerals are used to identify identical components in the various views, FIG. 1 illustrates a vehicle 10 and one embodiment of a training system 12 for training operators of vehicle 10. In the illustrated embodiment, vehicle 10 comprises a heavy commercial vehicle and, in particular, a tractor or power unit configured for towing one or more trailers or towed units. It should be understood, however, that the systems and methods disclosed herein may find application on other types of commercial vehicles including, for example, tractors operating without trailers, buses, etc. and may also find application on non-commercial vehicles. Vehicle 10 may comprise one member of a vehicle fleet. In addition to typical vehicle components (e.g., frame, axles, wheels, suspension, brakes, etc.), vehicle 10 may include an operator interface 14, various sensors 16, a telecommunications system 18, and control systems 20 for controlling various aspects of the operation of vehicle 10. Interface 14, sensors 16, telecommunications system 18 and control systems 20 may communicate with one another through direct electrical connections or over a conventional vehicle communications bus 22 implementing a communications network such as a controller area network (CAN) or local interconnect network (LIN) or over a vehicle power line through power line communication (PLC) in accordance with various industry standard protocols including by not limited to SAE J1939, SAEJ1922, and SAE J2497 or using a proprietary protocol.

Operator interface 14 provides an interface between the vehicle operator and sensors 16, telecommunications system 18 and control systems 20 through which the operator can control certain vehicle functions and receive information about the operation of vehicle 10. In accordance with one aspect of the systems and methods disclosed herein, operator interface 14 may further be configured to provide training modules generated by training system 12 to the vehicle operator. Interface 14 may be mounted within the cabin of vehicle 10 and, in particular, on the dashboard of vehicle 10. Interface 14 may assume various forms. Interface 14 may, for example, include a touch screen display with a graphical user interface (GUI). Interface 14 may include one or more handles, push buttons or switches through which an operator may input commands to vehicle 10. Interface 14 may also include light emitters, such as light emitting diodes, sound emitters, such as a speaker, and/or haptic actuators to output visual, audio and/or haptic messages to the vehicle operator. In the case of visual alerts, different information can be conveyed through differences in color, differences in intensity, differences in the number of lights, and differences in the pattern of activation of the lights. In the case of audio alerts, different information can be conveyed through differences in the type of sound generated, differences in volume and differences in the pattern of sounds. In the case of haptic alerts, different information can be conveyed through differences in the length, intensity, or pattern of vibration.

Sensors 16 are provided to identify various conditions associated with vehicle 10 and the surrounding environment including conditions that may impact the operation of vehicle 10. Sensors 16 may, for example, include speed sensors configured to determine the rotational speed of a component of vehicle 10 such as a wheel (i.e., a wheel speed sensor) or a power transmission shaft. Sensors 16 may include pressure sensors configured to determine atmospheric pressure or the pressure in a component of vehicle 10 such as tire, a brake actuator chamber, a compressor, or a conduit of a fluid circuit that delivers fluid to, or exhausts fluid from, another component of vehicle 10. Sensors 16 may include position sensors configured to determine a degree of rotation of a component of vehicle 10 such as a steering column component indicative of the steer angle for vehicle 10 (i.e., a steer angle sensor) or to determine the state or position of a component of vehicle 10 such as a brake pedal or door. Sensors 16 may include temperature sensors configured to determine ambient temperature in the area in which vehicle 10 is located or a localized temperature within vehicle 10. Sensors 16 may include moisture sensors configured to determine humidity. Sensors 16 may include altimeters configured to determine the altitude of vehicle 10 or the change in grade of the surface on which vehicle 10 is travelling. Sensors 16 may include GPS sensors or yaw rate sensors configured to determine the direction of travel of vehicle 10. Sensors 16 may include radar (radio detection and ranging) sensors, lidar (light detection and ranging) sensors, or cameras configured to output signals indicative of the presence of objects (e.g., other vehicles, pedestrians or road infrastructure) within a defined field of view and to provide information regarding the objects including, for example, the presence of the object within the field of view, the position or location of the object within the field of view and the distance between the object and vehicle 10. Sensors 16 may also include voltage or current sensors configured to measure the voltage or current level in component of vehicle 10. It should be understood that this listing of types of sensors 16 and the operating conditions measured or sensed by the sensors 16 is not meant to be exhaustive and that other types of sensors 16 could be employed within vehicle 10.

Telecommunications system 18 is provided to allow vehicle 10 to transmit information to, and receive information from, locations remote from the vehicle 10. Telecommunications system 18 enables communication between vehicle 10 and other vehicles (V2V communication), road infrastructure (V2I communication) and end users (e.g., fleet managers and vehicle service providers) overs various telecommunications networks. In accordance with the systems and methods disclosed herein, telecommunications system 18 also enables communication between vehicle 10 and training system 12. Telecommunications system 18 enables wireless voice and/or data communication over a wireless carrier system and via wireless networking. In some embodiments, telecommunications system 18 may comprise or form a part of a vehicle telematics unit used to provide a diverse range of services including turn-by-turn directions and other navigation-related services that are provided in conjunction with a GPS-based vehicle navigation system, airbag deployment or collision notification and other emergency or roadside assistance-related services, and diagnostic reporting using information obtained from various vehicle control systems. Telecommunications system 18 may include a short-range wireless communication transceiver for communicating with systems on vehicle 10 and for communication with other vehicles and road infrastructure that are configured for communication over a relatively short distance using short-range wireless technologies such as Wi-Fi (IEEE 802.11), WiMAX, Wi-Fi direct, Bluetooth, Zigbee, near field communication (NFC), etc. and that transmit and receive signals through an antenna. The transceiver may be configured to allow vehicle to vehicle communication in accordance with Society of Automotive Engineering (SAE) Standard J2945 directed to Dedicated Short Range Communication. Telecommunications system 18 may further include a long-range wireless communication transceiver that is configured for communication over longer distances through a cellular communications network 24 or satellite communication network 26 for vehicle navigation, diagnostic reporting, fleet management and other purposes including communication with training system 12. The transceiver may, for example, be configured for cellular communication according to either GSM, CDMA, UMTS or LTE standards and therefore include a standard cellular chipset for voice communications, a wireless modem (not shown) for data transmission, and a radio transceiver that transmits signals to and receives signals from a dual antenna for wireless communication with network 24. Using communication networks 24, 26 telecommunications system 18 may be connected to a telecommunications network 28 and, through network 28, to various computing devices including those forming a part of training system 12. Network 28 may include a public switched telephone network (PSTN) such as that used to provide hardwired telephony, packet-switched data communications, and the Internet infrastructure. One or more segments of network 28 could be implemented through the use of a standard wired network, a fiber or other optical network, a cable network, power lines, other wireless networks such as wireless local area networks (WLANs), or networks providing broadband wireless access (BWA), or any combination thereof. The computing devices may comprise, for example, servers (including file servers, web servers, or network address servers) or client computing devices and may be used for a wide variety of purposes including, for example, accessing or receiving vehicle data for use in diagnosing and servicing vehicle 10, setting up or configuring vehicle 10, controlling vehicle functions and connecting the vehicle operator to human advisors, automated voice response systems, databases, and the like used in providing, for example, information, emergency or roadside assistance services and vehicle diagnostic services and, in accordance with the systems and methods disclosed herein, assessing operator performance, recording information relating to safety events, and providing training modules to vehicle operators.

Control systems 20 are configured to control various aspects of the operation of vehicle 10 including, for example, vehicle starting or ignition, power generation and delivery, steering, braking, etc. Control systems 20 may include a plurality of advanced driver assistance systems (ADAS) or automated driving systems (ADS) including, but not limited to, forward collision warning systems, blind-spot warning systems, lane departure warning systems, cross traffic warning systems, automated emergency braking (AEB) systems, anti-lock braking (ABS) systems, collision avoidance systems, adaptive cruise control systems, traction control systems, stability control systems, lane keep assist systems or lane centering systems and parking assist systems. Each control system 20 may include one or more controllers 30. Controllers 30 may comprise programmable microprocessors or microcontrollers or may comprise application specific integrated circuits (ASIC). Each controller 30 may include a memory and a central processing unit (CPU). Each controller 30 may also include an input/output (I/O) interface including a plurality of input/output pins or terminals through which the controller 30 may receive a plurality of input signals and transmit a plurality of output signals. The controller 30 may, for example, receive input signals from any of operator interface 14, sensors 16, telecommunications system 18 or other control systems 20. The controller 30 may, for example, transmit output signals to any of operator interface 14, telecommunications system 18 or other control systems 20.

Training system 12 is provided for training operators of vehicle 10. System 12 may comprise one more computing devices (e.g., servers, personal computers, etc.) that are configured for communication with vehicle 10 through network 28. Training system 12 may include a database 32 and a controller 34.

Database 32 includes a plurality of training resources that may be used in training operators of vehicle 10. The training resources may include, for example, instructions for performing a task associated with operation of vehicle 10 (e.g., how to properly apply the vehicle brakes, how to handle operation of the vehicle during different weather events, etc.) and tests for testing the knowledge of the operator regarding safe operation of vehicle 10. The training resources may be provided in a variety of formats including text and/or graphics, audio clips, videos, and/or audiovisual files. The training resources may be passive such that the operator only reviews or observes the training resource or interactive such that the operator is required to interact with the training resource (e.g., by responding to questions, confirming understandings or acknowledging review). The training resources may be organized in a conventional data structure (e.g., a lookup table) within database 32 such that controller 34 is able to identify and extract training resources within database 32 based on various criteria.

Controller 34 is provided to gather data from vehicle 10 regarding the operation of vehicle 10, determine whether training is needed by an operator of vehicle 10 and, if so, generate appropriate training for the operator. Controller 34 may also implement restrictions on the operation of vehicle 10 in response to the data regarding operation of the vehicle and/or the results of efforts to train the operator. Controller 34 may comprise a programmable microprocessor or microcontroller or may comprise an application specific integrated circuit (ASIC). Controller 34 may include a memory 36 and a central processing unit (CPU) 38. Controller 34 may also include an input/output (I/O) interface 40 including a plurality of input/output pins or terminals through which the controller 34 may receive a plurality of input signals and transmit a plurality of output signals. The input signals, may, for example, include signals transmitted by vehicle 10 to training system 12 over network 28 indicative of the operation of vehicle 10. The output signals may, for example, include signals transmitted by training system 12 to vehicle 10 or an operator-held computing device 42 (e.g., a smart phone) over network 28 to provide training modules to the operator of vehicle 10 and signals transmitted by training system 12 to vehicle 10 over network 28 to control the operation of vehicle 10. Controller 34 may be configured with appropriate programming instructions (i.e., software or a computer program) to implement various steps in a method for training an operator of vehicle 10. The instructions or computer program may be encoded on a non-transitory computer storage medium such as a memory within, or accessible by, controller 34.

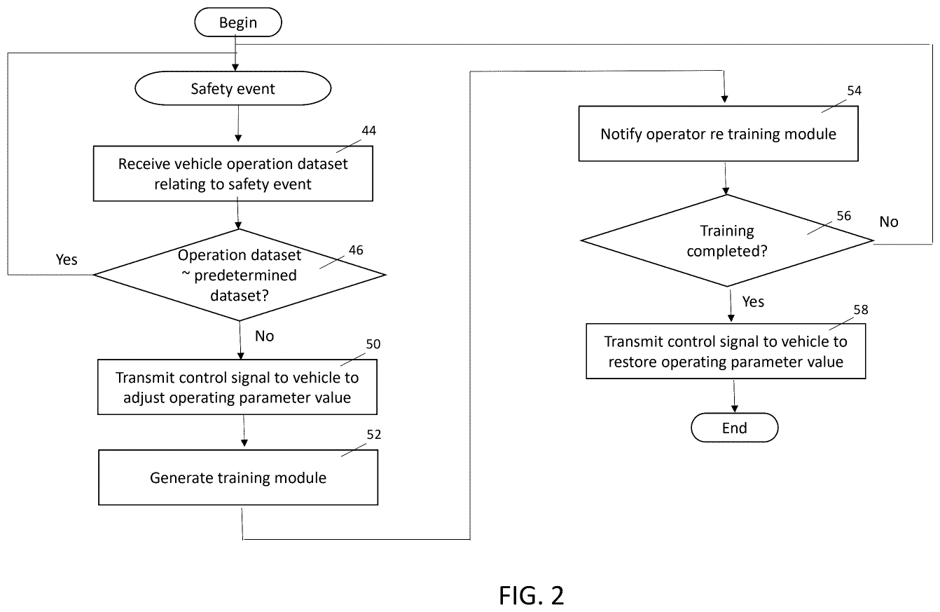

Referring now to FIG. 2, the method may begin with the step 44 of receiving a vehicle operation dataset from vehicle 10 relating to a safety event occurring during operation of vehicle 10 by the operator. System 12 may receive the vehicle operation dataset over a telecommunications channel formed, for example, over network 28. A safety event may comprise an event in which certain control systems 20 are activated. In particular, a safety event may comprise an event in which an advanced driver assistance system (ADAS) or automated driving system (ADS) is activated to provide a warning to the vehicle operator and/or to provide assistance to the operator in operating vehicle 10. In one embodiment, the safety event may comprise activation of an automated emergency braking system on vehicle 10. Other safety events may comprise, for example, a high speed of vehicle 10 (i.e., where the speed of vehicle 10 exceeds a threshold), a high deceleration of vehicle 10 by the operator (i.e., where the rate of deceleration or braking of vehicle 10 by the operator exceeds a threshold), a loss of stability of vehicle 10, a high lateral acceleration or longitudinal acceleration of vehicle 10 (i.e., where the rate of acceleration of vehicle 10 exceeds a threshold), movement of vehicle 10 into a restricted area, a reduction in the following distance between vehicle 10 and an object in front of vehicle 10 or a lane or roadway departure of vehicle 10 (e.g., where the amount of vehicle 10 departing from the lane of travel or roadway exceeds a threshold). A vehicle operation dataset is comprised of data relating to the occurrence of the safety event and may include data obtained during the occurrence of the safety event as well as data obtained prior to the safety event (for evaluation of conditions leading to the safety event) and after the safety event (for evaluation of handling of the safety event). This data may be stored in memories on vehicle 10 including memories within controllers 30 of systems 20. The vehicle operation dataset may, for example, include data obtained from sensors 16 when the safety event occurred and during predetermined periods of time before and after the safety event. For example, the vehicle operation dataset may include information relating to the speed at which the vehicle was traveling during the safety event, and periods of time before after the safety event, as detected by wheel speed sensors. The vehicle operation dataset may include information relating to the direction of travel of vehicle 10 during the safety event, and periods of time before after the safety event, as indicated by steer angle sensors and yaw angle sensors. The vehicle operation dataset may also include information relating to the presence of objects surrounding vehicle 10 and distances to such objects during the safety event, and periods of time before after the safety event, as indicated by LIDAR sensors, RADAR sensors or cameras, etc. The vehicle operation dataset may also include data obtained from systems 20 when the safety event occurred and during predetermined periods of time before and after the safety event including, for example, information on the time the safety event occurred and the duration of the safety event.

The method may continue with the step 46 of determining whether the vehicle operation dataset corresponds to a predetermined dataset. The comparison between the vehicle operation dataset and the predetermined dataset is intended to determine whether operation of vehicle 10 should be restricted and whether the vehicle operator should be required to undergo additional training regarding operation of vehicle 10. For example, the comparison may indicate that the operator failed to maintain an appropriate distance between the vehicle 10 and another vehicle leading to a safety event such as activation of automated emergency braking or that the operator failed to maintain the vehicle 10 within a lane of travel leading to a safety event such as activation of a lane departure warning system or lane keep assist system. The comparison may therefore indicate that the operator requires additional training in maintaining a proper following distance and/or maintaining the vehicle 10 within a lane of travel.

Controller 34 may select the predetermined dataset from among a plurality of different predetermined datasets that are stored in a memory such as memory 36 or database 32. Different predetermined datasets may be established based on, for example, different types of safety events and controller 34 may select among the plurality of predetermined datasets based on the type of safety event that triggered transmittal of the vehicle operation dataset in step 44.

It should be understood that the comparison between the vehicle operation dataset and the predetermined dataset will vary depending on the type of safety event and the nature and scope of the vehicle operation dataset and predetermined dataset. For example, controller 34 may determine whether the datasets correspond based on a single data element within each dataset (e.g., whether a speed of vehicle 10 when a safety event occurred (obtained from the vehicle operation dataset) is less than a predetermined speed (obtained from the predetermined dataset)) or determine whether the datasets correspond based on of multiple data elements within the datasets (e.g., whether a speed of vehicle 10 and the distance to an object near vehicle 10 when a safety event occurred (both obtained from the vehicle operation dataset) are, respectively, less than a predetermined speed and greater than a predetermined distance (both obtained from the predetermined dataset)). Controller 34 may determine whether the datasets correspond based on whether a given data element in the vehicle operation dataset is present or absent, whether the data element has a value that is greater than, greater than or equal to, less than, less than or equal to, or equal to a predetermined value in the predetermined dataset or is within a predetermined range relative to the predetermined value.

In accordance with one aspect of the systems and method disclosed herein, the predetermined dataset can be modified. System 12 and, in particular, controller 34 is configured to receive tuning signals configured to establish the predetermined dataset. In this manner, vehicle owners can customize the predetermined dataset to establish standards that are selected by the vehicle owner to ensure that vehicle operators obtain the desired amount and type of training as opposed to relying on a dataset established by the system developer that may default to standards resulting in undue amounts of training for operators. Controller 34 may, for example, be configured to generate a graphical user interface on a computing device 48 (see FIG. 1) such as a desktop, laptop or handheld computer or smart phone through which a vehicle owner can generate and transmit tuning signals to controller 34 to modify a predetermined dataset.

If the vehicle operation dataset corresponds to the predetermined dataset, system 12 may determine that no further action is required. In particular, if the vehicle operation dataset corresponds to the predetermined dataset, system 12 may determine that the safety event was not caused by a failure of the operator of vehicle, but instead had other causes (e.g., the actions of the operator of a different vehicle on the roadway).

If the vehicle operation dataset does not correspond to the predetermined dataset, the method may continue with the step 50 of transmitting a control signal to vehicle 10 over the telecommunications channel between vehicle 10 and system 12 that is configured to adjust a value of a parameter associated with operation of vehicle 10. Depending on the nature of the parameter and the adjustment to the parameter value, the operator may be unable to operate vehicle 10 or may experiences changes in the operation of vehicle 10 relative to the operation of vehicle 10 prior to transmission of the control signal. For example, in one embodiment, the parameter may comprise the following distance (as measured in terms of distance (e.g., meters) or time (e.g., seconds)) between vehicle 10 and another object in front of vehicle 10 at which a warning is issued to the operator of vehicle 10 and/or at which automated emergency braking of vehicle 10 occurs. The control signal may increase the value of the following distance such that the warning is issued and/or assistance is provided sooner than they would have been issued or provided prior to the safety event. In another embodiment, the parameter may comprise a configuration for issuance of the warnings or assistance. For example, the applicant offers an advanced driver assistance system under the trademark “WINGMAN FUSION.” This system allows vehicle owners to select one of a plurality of configurations establishing various following distances at which different warnings—a slow repeating beep, a faster (“medium”) repeating beep, and a fast repeating beep—are provided to the operator. The control signal may modify the configuration from a previously selected configuration to a configuration that increases the following distances for one or more of the warnings such that one or more of the warnings is issued earlier than they would have been issued prior to the safety event. In other embodiments, the following distances could remain the same, but the type of warning issued at each distance could be adjusted to increase the intensity of the warnings (e.g., a warning that is relatively short in duration (momentary) could be changed to a warning that is longer in duration (continuous)).

If the vehicle operation dataset does not correspond to the predetermined dataset, the method may also include the step 52 of generating a training module for the operator of vehicle 10. The training module will include at least one of the plurality of training resources from database 32. Controller 34 may select one or more training resources from database 32 based on one or more criteria such as the nature/type of safety event, the reason(s) why the vehicle operation dataset did not correspond to the predetermined dataset (e.g., where only selected data elements in the dataset are not in agreement) and/or operator history (e.g., if an operator has undergone similar training previously, a more intensive training resource may be selected). In accordance with one aspect of the systems and methods disclosed herein, the training module may also include data from the vehicle operation dataset and, further, a comparison of the data from the vehicle operation dataset against data from the predetermined dataset. In this manner, the system 12 is able to customize training for the operator of vehicle 10 so that the training is directly related to the actions of the operator and more likely to have a beneficial effect. The training module may, for example, provide information on standard operation of vehicle 10 (as defined by the vehicle owner in the predetermined dataset), information on the operation of vehicle 10 by the vehicle operator (as reflected in the vehicle operation dataset) and an indication (e.g., textual, graphical, etc.) of the difference between the two as an introduction to the training resource. In some cases, system 12 may integrate information from the vehicle operation dataset and/or predetermined dataset and the training resource. For example, if the training resource comprises a video showing proper operation of vehicle 10, video from the vehicle operation dataset captured by cameras on vehicle 10 could be overlayed onto the training resource video to demonstrate deviation from proper operation of vehicle 10.

After generating the training module, the method may continue with the step 54 of transmitting one or more training signals configured to notify the operator of the availability of the training module and a requirement for the operator to use the training module. Controller 34 may, for example, transmit a training signal to vehicle 10 over the same communication channel used to receive the vehicle operation dataset. The signal may cause operator interface 14 to alert the operator of the availability, and requirement to use, the training module. Alternatively, controller 34 may transmit a training signal to another computing device 42 associated with the operator (e.g., a smart phone) to cause the device 42 to alert the operator of the availability, and requirement to use, the training module. Depending on the nature of the training module, the operator may use the training module within vehicle 10 (e.g., using operator interface 14) or outside of vehicle 10 (e.g., using device 42).

In accordance with another aspect of the systems and methods disclosed herein, the method may continue with the step 56 of determining whether use of the training module by the operator meets a predetermined condition. In the case of a passive training module that does not require interaction by the operator, the predetermined condition may be, for example, that the operator completed the training module (e.g., reviewed all required components of a training module (and, possibly, acknowledged review of each component), that the operator completed a predetermined amount of the training module or that the operator at least accessed the training module. In situations where the training module is interactive and requires interaction from the operator, the predetermined condition may measure the nature or degree of interaction with the training module (e.g., whether the operator has correctly answered or all or a percentage of a series of test questions correctly).

If the operator's use of the training module does not meet the predetermined condition (indicating that the operator failed to use the training module or failed to learn from use of the training module), operation of the vehicle 10 may continue with the adjusted parameter value from step 50. If, however, the operator's use of the training module meets the predetermined condition, controller 34 may be configured in step 58 to transmit another control signal to vehicle 10 over the telecommunications channel between vehicle 10 and system 12 that is configured to restore the original value of the parameter associated with operation of vehicle 10. In this manner, system 12 increases the likelihood that the operator will perform suggested training and take the training seriously and improves the safety of operation of vehicle 10 in situations where the operator fails to do so. In some embodiments, the control signal in step 58 may be configured to restore the original value for only a predetermined time period (e.g., one established by an owner of vehicle 10) or until a predetermined event occurs (e.g., another safety event).

In accordance with another aspect of the systems and methods disclosed herein, system 12 may also be configured to generate training modules for operators of vehicle 10 responsive to predicted, future conditions that increase the likelihood of a safety event. For example, if precipitation is anticipated (thereby reducing friction between the wheels on vehicle 10 and the road surface and increasing braking distances), system 12 may be configured to generate an appropriate training module for the operator in advance of the conditions occurring. Controller 34 may therefore be configured to identify a presence of a condition increasing the likelihood that a safety event will occur at a future time and to generate, when the condition is present, a training module for the operator. Controller 34 may be configured to identify the presence of the condition responsive to information obtained from one or more sensors 16 or systems 20 on vehicle 10 or in response to information provided to controller 34 from other sources over network 28.

In accordance with another aspect of the systems and methods disclosed herein, system 12 may also be configured to generate training modules for operators of vehicle 10 responsive to information relating to past training for the operator. For example, if a training module for a particular subject has previously been generated for an operator on multiple occasions, controller 34 may be configured to generate a training module relating to that subject that is longer in duration and/or provides more information relating to the subject than the previous training module. Controller 34 may also be configured to generate a training module relating to the subject that is interactive (requiring interaction by the operator) if the previous training module was passive (and did not require interaction by the operator).

A system 12 and method for training an operator of a vehicle 10 in accordance with the teachings disclosed herein is advantageous relative to conventional systems and methods. In particular, various embodiments of the system 12 and method disclosed herein allow for customization of vehicle operator training based on factors including prior operation of the vehicle 10 by the vehicle operator and training preferences by the vehicle owner and/or increase the likelihood that a vehicle operator will perform suggested training.

While the invention has been shown and described with reference to one or more particular embodiments thereof, it will be understood by those of skill in the art that various changes and modifications can be made without departing from the spirit and scope of the invention.

What is claimed is:

1. A system for training an operator of a vehicle, comprising:
a database including a plurality of training resources;
a controller configured to
receive, over a first telecommunications channel, a vehicle operation dataset from the vehicle relating to a safety event occurring during operation of the vehicle by the operator;
determine whether the vehicle operation dataset corresponds to a predetermined dataset;
transmit, if the vehicle operation dataset does not correspond to the predetermined dataset, a first control signal to the vehicle over the first telecommunications channel, the first control signal configured to adjust a value of a parameter associated with operation of the vehicle from a first value to a second value;
generate, if the vehicle operation dataset does not correspond to the predetermined dataset, a training module for the operator wherein the training module includes at least one of the plurality of training resources;
determine whether use of the training module by the operator meets a predetermined condition; and,
transmit, if use of the training module by the operator meets the predetermined condition, a second control signal to the vehicle over the first telecommunications channel, the second control signal configured to restore the value of the parameter associated with operation of the vehicle to the first value.

2. The system of claim 1 wherein the first telecommunications channel comprises a wireless communications channel.

3. The system of claim 1 wherein the safety event comprises one of an automated emergency braking of the vehicle, a high deceleration of the vehicle by the operator, a loss of stability of the vehicle, a high lateral acceleration of the vehicle, a high longitudinal acceleration of the vehicle, movement of the vehicle into a restricted area, and a reduction in a following distance between the vehicle and an object in front of the vehicle.

4. The system of claim 1 wherein the controller is further configured to receive tuning signals configured to establish the predetermined dataset.

5. The system of claim 1 wherein the training module includes data from the vehicle operation dataset.

6. The system of claim 5 wherein the training module includes a comparison of the data from the vehicle operation dataset against data from the predetermined dataset.

7. The system of claim 1 wherein the controller is further configured to transmit a training signal to one of the vehicle over the first telecommunications channel and a device associated with the operator over a second telecommunications channel, the training signal configured to notify the operator of a requirement for the operator to use the training module.

8. The system of claim 1 wherein the parameter comprises a distance between the vehicle and another object at which automated emergency braking of the vehicle occurs.

9. The system of claim 1 wherein the parameter comprises a distance between the vehicle and another object at which a warning is issued to the operator by the vehicle.

10. The system of claim 1 wherein the controller is further configured to:
identify a presence of a condition increasing a likelihood that the safety event will occur at a future time; and
generate, when the condition is present, the training module for the operator.

11. A method for training an operator of a vehicle, comprising:
receiving, over a first telecommunications channel, a vehicle operation dataset from the vehicle relating to a safety event occurring during operation of the vehicle by the operator;
determining whether the vehicle operation dataset corresponds to a predetermined dataset;
transmitting, if the vehicle operation dataset does not correspond to the predetermined dataset, a first control signal to the vehicle over the first telecommunications channel, the first control signal configured to adjust a value of a parameter associated with operation of the vehicle from a first value to a second value;
generating, if the vehicle operation dataset does not correspond to the predetermined dataset, a training module for the operator wherein the training module includes at least one of a plurality of training resources from a database;
determining whether use of the training module by the operator meets a predetermined condition; and,
transmitting, if use of the training module by the operator meets the predetermined condition, a second control signal to the vehicle over the first telecommunications channel, the second control signal configured to restore the value of the parameter associated with operation of the vehicle to the first value.

12. The method of claim 11 wherein the first telecommunications channel comprises a wireless communications channel.

13. The method of claim 11 wherein the safety event comprises one of an automated emergency braking of the vehicle, a high deceleration of the vehicle by the operator, a loss of stability of the vehicle, a high lateral acceleration of the vehicle, a high longitudinal acceleration of the vehicle, movement of the vehicle into a restricted area, and a reduction in a following distance between the vehicle and an object in front of the vehicle.

14. The method of claim 11 wherein further comprising receiving tuning signals configured to establish the predetermined dataset.

15. The method of claim 11 wherein the training module includes data from the vehicle operation dataset.

16. The method of claim 15 wherein the training module includes a comparison of the data from the vehicle operation dataset against data from the predetermined dataset.

17. The method of claim 11, further comprising transmitting a training signal to one of the vehicle over the first telecommunications channel and a device associated with the operator over a second telecommunications channel, the training signal configured to notify the operator of a requirement for the operator to use the training module.

18. The method of claim 11 wherein the parameter comprises a distance between the vehicle and another object at which automated emergency braking of the vehicle occurs.

19. The method of claim 11 wherein the parameter comprises a distance between the vehicle and another object at which a warning is issued to the operator by the vehicle.

20. The method of claim 11, further comprising:
identifying a presence of a condition increasing a likelihood that the safety event will occur at a future time; and
generating, when the condition is present, the training module for the operator.
